(19) United States
(12) Patent Application Publication
(10) Pub. No.: US 2010/0246021 A1
(43) Pub. Date: Sep. 30, 2010

(54) FLAT PRISM SHEET FOR BACKLIGHT UNITS AND METHOD OF MANUFACTURING THE SAME

(75) Inventor: Gi Suk Sung, Seongnam-Si (KR)

Correspondence Address: LRK Patent Law Firm, 1952 Gallows Rd, Suite 200, Vienna, VA, 22182, US

(73) Assignees: Soo CHOI, Seoul (KR); Gi Suk SUNG, Seongnam-Si (KR); ON-NURI ELECTRONICS INC., LTD., Seoul (KR)

(21) Appl. No.: 12/738,975

(22) PCT Filed: Oct. 29, 2007
(86) PCT No.: PCT/KR07/05347

§ 371 Date: May 3, 2010

(30) Foreign Application Priority Data
Nov. 1, 2006 (KR) 10-2006-0107148

(51) Int. Cl. G02B 27/10; B32B 37/02; B32B 38/06; B29D 11/00

(52) U.S. Cl. 359/625; 156/275.5; 156/292; 156/242

(57) ABSTRACT

This invention relates to a flat prism sheet for backlight units and a method of manufacturing the same, and particularly, to a flat prism sheet, which has flat upper and lower surfaces and prism-shaped protrusions formed therein, and to a method of manufacturing the same. The flat prism sheet for backlight units according to this invention includes a lower layer, a first intermediate layer formed on the upper surface of the lower layer and having a plurality of prism-shaped protrusions formed parallel to each other, a second intermediate layer formed on the upper surface of the first intermediate layer, and an upper layer formed on the upper surface of the second intermediate layer, wherein an air layer is formed between the lower surface of the second intermediate layer and the valleys of the prism-shaped protrusions of the first intermediate layer.

### TECHNICAL FIELD

The present invention relates to a flat prism sheet for backlight units and a method of manufacturing the same. More particularly, the present invention relates to a flat prism sheet for backlight units, which has flat upper and lower surfaces and prism-shaped protrusions formed therein, and to a method of manufacturing the same.

### BACKGROUND ART

FIG. 1 illustrates the construction of a conventional backlight unit.

As illustrated in FIG. 1, in the conventional backlight unit, a fluorescent lamp 1, which is a linear light source, and a lamp reflection plate 2 for reflecting the light of the fluorescent lamp 1 are disposed to one side of a light guide plate 3 for converting the light from the fluorescent lamp 1 into a surface light source, and a reflection plate 4 for preventing leakage of light is disposed under the light guide plate 3. Further, a diffusion plate 5 for uniformly diffusing light is placed on the light guide plate 3, and prism sheets 6, 7 respectively having a plurality of triangular linear prisms 8, 9 to collect scattered light are sequentially placed on the diffusion plate 5. Two prism sheets 6, 7 are disposed so that linear prisms 8, 9 are perpendicular to each other, thus collecting light radiated in different directions. On the upper prism sheet 9, a protective sheet 10 for protecting the prisms from being scratched and preventing the entry of impurities between the prisms is disposed. The individual constituents are assembled, thereby completing a backlight unit.

FIG. 2 illustrates the cross-section of a conventional prism sheet for backlight units.

As illustrated in FIG. 2, the lower surface of the conventional prism sheet is flat, and the upper surface thereof has a plurality of prism-shaped protrusions 201 formed parallel to each other, so that light may be collected in a direction (z-axis direction) perpendicular to the prism-shaped protrusions thanks to the presence of the prism-shaped protrusions.

However, because the conventional prism sheet has the prism-shaped protrusions on one surface thereof, defects caused by scratching of the prism-shaped protrusions and by the entry of small impurities into the valleys between the prism-shaped protrusions and shatter cracks caused by cutting of the prism-shaped protrusions, attributable to friction with the protective sheet, may be generated when the backlight unit is assembled. Hence, even though the backlight unit is carefully assembled, many assembly defects may occur, undesirably decreasing productivity, and furthermore, in the case where defects occur, the manufacturing process should be conducted again, resulting in high material cost loss.

Accordingly, a transparent adhesive sheet is attached to both surfaces of the prism sheet to protect the prism-shaped protrusions and prevent the entry of impurities. However, because the transparent adhesive sheet must be removed in the course of assembling the backlight unit, it is impossible to eliminate defects caused by scratching and friction. Moreover, when the transparent adhesive sheet is removed, static electricity is generated, even in the presence of an apparatus for removing static electricity, whereby impurities are attracted inward, thus making it impossible to greatly decrease assembly defect rates. In addition, the need to reduce costs associated with the use of the adhesive sheet has arisen.

### DISCLOSURE OF INVENTION

### Technical Problem

Accordingly, the present invention has been made keeping in mind the above problems occurring in the related art, and provides a flat prism sheet, in which prism-shaped protrusions are formed in the prism sheet so as to protect the prism-shaped protrusions from being scratched and prevent the entry of impurities into the valleys between the prism-shaped protrusions in the course of assembling a backlight unit, and also provides a method of manufacturing the same.

### Technical Solution

According to the present invention, a flat prism sheet for backlight units may include a lower layer, a first intermediate layer formed on the upper surface of the lower layer and having a plurality of prism-shaped protrusions formed parallel to each other, a second intermediate layer formed on the upper surface of the first intermediate layer, an upper layer formed on the upper surface of the second intermediate layer, and an air layer formed between the lower surface of the second intermediate layer and the valleys of the prism-shaped protrusions of the first intermediate layer.

### BRIEF DESCRIPTION OF THE DRAWINGS

FIG. 1 is an exploded perspective view illustrating a conventional backlight unit;

FIG. 2 is a cross-sectional view illustrating a conventional prism sheet;

FIGS. 3 and 4 are cross-sectional views illustrating the flat prism sheet according to a first embodiment of the present invention;

FIG. 5 is a cross-sectional view illustrating the flat prism sheet according to a second embodiment of the present invention;

FIG. 6 is a cross-sectional view illustrating the flat prism sheet according to a third embodiment of the present invention;

FIG. 7 is cross-sectional views illustrating the prism-shaped protrusion according to the present invention;

FIG. 8 is a flowchart illustrating the process of manufacturing the flat prism sheet according to the first embodiment of the present invention;

FIG. 9 is a flowchart illustrating the process of manufacturing the flat prism sheet according to the second embodiment of the present invention: and

FIG. 10 is a flowchart illustrating the process of manufacturing the flat prism sheet according to the third embodiment of the present invention.

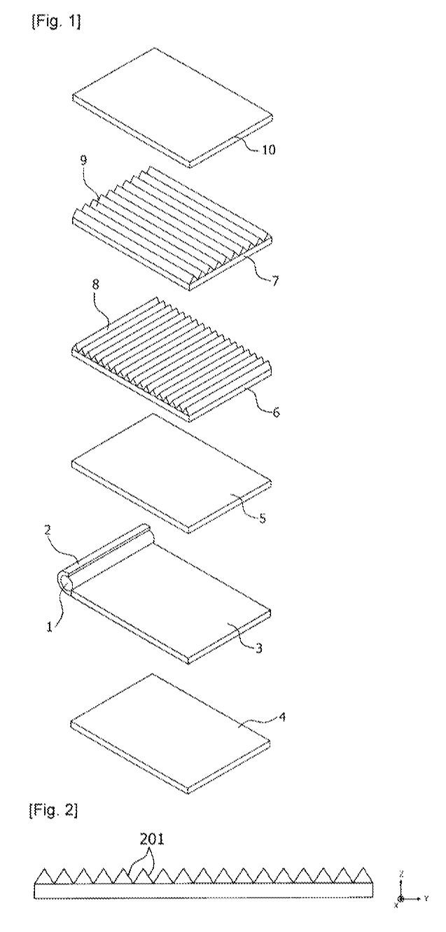

### MODE FOR THE INVENTION

Hereinafter, a detailed description will be given of the preferred embodiments of the present invention with reference to the appended drawings.

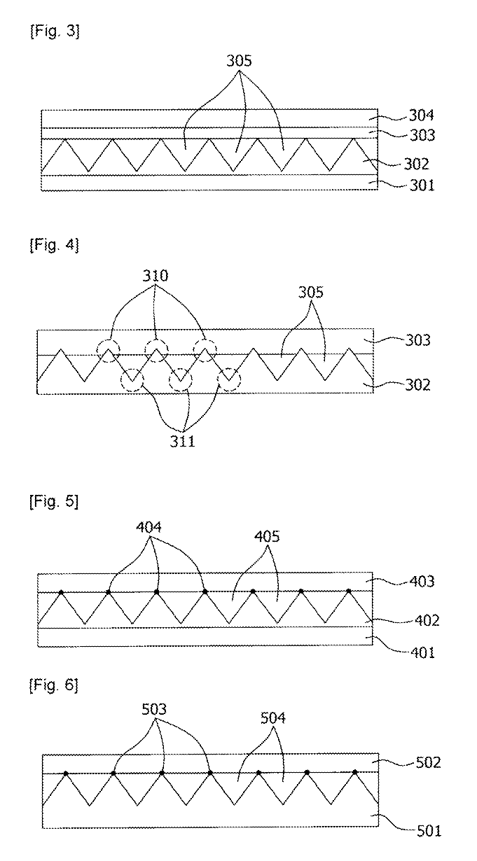

FIG. 3 is a cross-sectional view illustrating the flat prism sheet according to a first embodiment of the present invention.

As illustrated in FIG. 3, the flat prism sheet according to the first embodiment of the present invention is composed of a lower layer 301, a first intermediate layer 302, a second intermediate layer 303, an upper layer 304, and an air layer 305.

The lower layer 301 and the upper layer 304 are formed of synthetic resin, such as

PET (polyethyleneterephthalate).

The first and second intermediate layers 302, 303 are formed of a UV light-curable acrylic resin or a heat-curable acrylic resin.

In the first intermediate layer 302, a plurality of prism-shaped protrusions, cross-sections of which have a triangular shape or a polygonal shape having five or more sides, similar to the triangular shape, is formed parallel to each other, in order to collect light in a direction perpendicular to the upper and lower surfaces of the flat prism sheet.

FIG. 4 is an enlarged cross-sectional view illustrating the intermediate layer according to the first embodiment.

As illustrated in FIG. 4, the ridges 310 of the prism-shaped protrusions of the first intermediate layer 302 are embedded in the lower surface of the second intermediate layer 303, and the ridges of the prism-shaped protrusions of the first intermediate layer are integrated with the lower surface of the second intermediate layer through fusion. Further, an air layer 305 is formed between the lower surface of the second intermediate layer 303 and the valleys 311 of the prism-shaped protrusions.

In this case, the prism-shaped protrusions are constructed in a manner such that the ridges thereof come into contact with the lower surface of the second intermediate layer to thus slightly overlap, so as to avoid a great change in the prism-shaped protrusions. This is because excessive overlapping weakens the functionality of the prism.

The reason why the air layer 305 is formed is as follows. That is, because the refractive index of air is 1 and the refractive index of material other than air is greater than 1, in the case where the above space is filled with material other than air, the effect of collecting light in the direction perpendicular to the upper and lower surfaces of the flat prism sheet is decreased, as per Snell' law. Thus, the intention is to maximize a light collection effect.

FIG. 5 is a cross-sectional view illustrating the flat prism sheet according to a second embodiment of the present invention.

As illustrated in FIG. 5, the prism sheet is composed of a lower layer 401, an intermediate layer 402, an upper layer 403. an adhesive 404, and an air layer 405.

The lower layer 401 is formed of PET, the intermediate layer 402 is formed of a UV light-curable acrylic resin or a heat-curable acrylic resin, and the upper layer 403 is formed of PET, or PC (polycarbonate), which is a thermoplastic resin.

In the intermediate layer 402, a plurality of prism-shaped protrusions, cross-sections of which have a triangular shape or a polygonal shape having five or more sides, similar to the triangular shape, is formed parallel to each other, in order to collect light in a direction perpendicular to the upper and lower surfaces of the flat prism sheet.

Further, a small amount of the adhesive 404 is applied on the ridges of the prism-shaped protrusions of the intermediate layer 402, and the ridges of the prism-shaped protrusions are integrated with the lower surface of the upper layer 403 through adhesion using the adhesive. The adhesive includes, for example, highly transparent polymers, such as silicone-urethane (SU) hybrid polymers, acrylic polymers, and polyester based polymers. In the case where too much adhesive is used, the functionality of the prism is weakened, and stain defects may occur. Preferably, the adhesive is used in as small an amount as possible while still maintaining adhesion.

The reason why the air layer 405 is. formed between the lower surface of the upper layer 403 and the valleys of the prism-shaped protrusions of the intermediate layer 402 is the same as in the first embodiment.

FIG. 6 is a cross-sectional view illustrating the flat prism sheet according to a third embodiment of the present invention.

As illustrated in FIG. 6, the prism sheet is composed of a lower layer 501, an upper layer 502, an adhesive 503, and an air layer 504.

The lower layer 501 is formed of PC, and, in the lower layer 501, a plurality of prism-shaped protrusions, cross-sections of which have a triangular shape or a polygonal shape having five or more sides, similar to the triangular shape, is formed parallel to each other, in order to collect light in a direction perpendicular to the upper and lower surfaces of the flat prism sheet.

Further, a small amount of the adhesive 503 is applied on the ridges of the prism-shaped protrusions of the lower layer 501, and the ridges of the prism-shaped protrusions are integrated with the lower surface of the upper layer 502 through adhesion using the adhesive. The adhesive includes, for example, highly transparent polymers, such as silicone-urethane (SU) hybrid polymers, acrylic polymers, and polyester-based polymers. In the case where too much adhesive is used, the functionality of the prism is weakened, and stain defects may occur. Preferably, the adhesive is used in as small an amount as possible while still maintaining adhesion.

The upper layer 502 is formed of PET or PC.

The reason why the air layer 504 is formed between the lower surface of the upper layer 502 and the valleys of the prism-shaped protrusions of the lower layer 501 is the same as in the first embodiment.

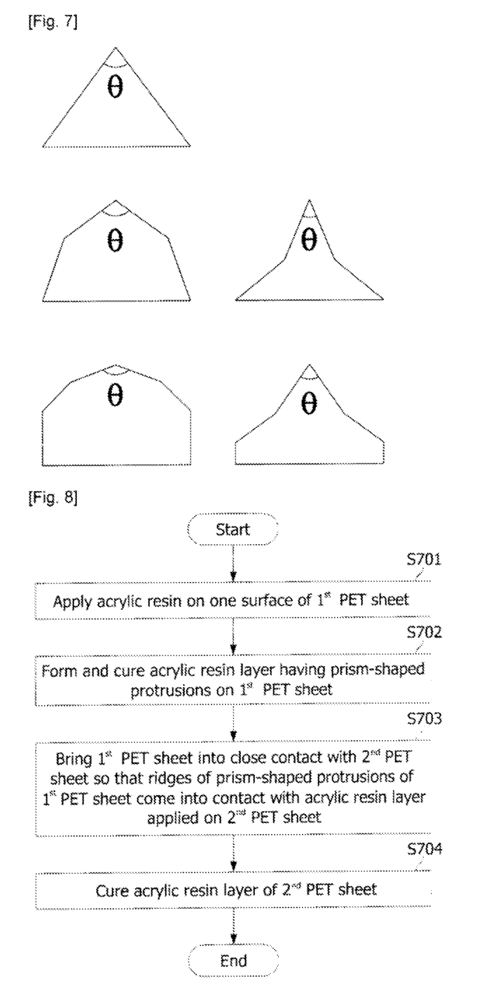

FIG. 7 illustrates the cross-sections of the prism-shaped protrusion according to the present invention.

As illustrated in FIG. 7, cross-sections of the prism-shaped protrusions may have a triangular shape, or a polygonal shape, including a pentagonal shape or a heptagonal shape, similar to the triangular shape.

The angles (θ) of the ridges of the prism-shaped protrusions, which are brought into contact with the second intermediate layer 303 or the upper layer 403, 502, range from 60° to 120° and the intervals between the ridges of the prism-shaped protrusions, which are formed in the first intermediate layer 302, the intermediate layer 402, or the lower layer 501, range from 20° to 150°.

FIG. 8 is a flowchart illustrating the process of manufacturing the flat prism sheet according to the first embodiment of the present invention.

The method of manufacturing the flat prism sheet according to the first embodiment includes applying a UV light-curable acrylic resin or a heat-curable acrylic resin in an uncured state to a predetermined thickness on one surface of a first PET sheet (S701); passing the first PET sheet, coated with the uncured acrylic resin, through a roll having prism-shaped recesses to thus form an uncured acrylic resin layer having prism-shaped protrusions on the first PET sheet. and then radiating UV light or applying heat to thus completely cure the uncured acrylic resin layer having the prism-shaped protrusions (S702); applying a UV light-curable acrylic resin or a heat-curable acrylic resin in an uncured state to a predetermined thickness on one surface of a second PET sheet to thus form an uncured acrylic resin layer, and then bringing the first PET sheet into close contact with the second PET sheet so that the ridges of the prism-shaped protrusions of the first PET sheet come into contact with the uncured acrylic resin layer of the second PET sheet, under pressure set so that the ridges of the prism-shaped protrusions of the first PET sheet arc not brought into direct contact with one surface of the second PET sheet but slightly overlap with the acrylic resin layer of the second PET sheet, in a state in which the first PET sheet is positioned on the second PET sheet such that the uncured acrylic resin applied on the second PET sheet does not flow down along the prism-shaped protrusions (S703); and radiating UV light or applying heat to thus completely cure the acrylic resin layer of the second PET sheet (S704).

FIG. 9 is a flowchart illustrating the process of manufacturing the flat prism sheet according to the second embodiment of the present invention.

The method of manufacturing the flat prism sheet according to the second embodiment includes applying a UV light-curable acrylic resin or a heat-curable acrylic resin in an uncured state to a predetermined thickness on one surface of a first PET sheet (S801); passing the first PET sheet, coated with the acrylic resin, through a roll having prism-shaped recesses to thus form an uncured acrylic resin layer having prism-shaped protrusions on the first PET sheet, and then radiating UV light or applying heat to thus completely cure the uncured acrylic resin layer having the prism-shaped protrusions (S802); disposing the ridges of the prism-shaped protrusions of the acrylic resin layer to face downward so that adhesive does not flow down along the prism-shaped protrusions of the acrylic resin layer of the first PET sheet, applying the adhesive on the ridges of the prism-shaped protrusions, and then bringing the first PET sheet into close contact with a second PET sheet or a PC sheet so that the ridges of the prism-shaped protrusions of the first PET sheet come into contact with one surface of the second PET sheet or the PC sheet in a state in which the first PET sheet is positioned on the second PET sheet or the PC sheet (S803); and drying the applied adhesive (S804).

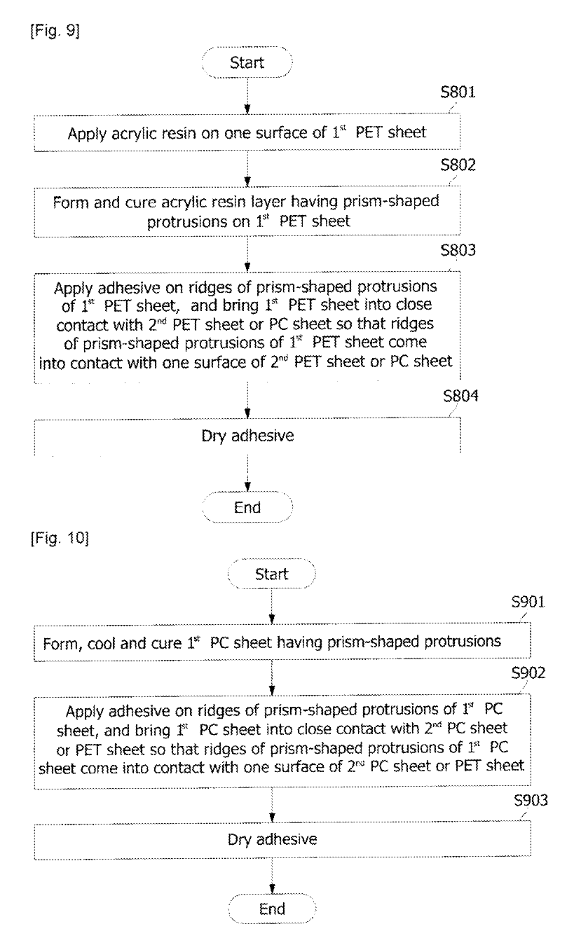

FIG. 10 is a flowchart illustrating the process of manufacturing the flat prism sheet according to the third embodiment of the present invention.

The method of manufacturing the flat prism sheet according to the third embodiment includes passing a first PC sheet through a heated roll having prism-shaped recesses to thus form the first PC sheet having prism-shaped protrusions, and then cooling the first PC sheet to thus cure it (S901); disposing the ridges of the prism-shaped protrusions of the first PC sheet to face downward so that adhesive does not flow down along the prism-shaped protrusions of the first PC sheet, applying the adhesive on the ridges of the prism-shaped protrusions, and then bringing the first PC sheet into close contact with a PET sheet or a second PC sheet so that the ridges of the prism-shaped protrusions of the first PC sheet come into contact with one surface of the PET sheet or the second PC sheet in a state in which the first PC sheet is positioned on the PET sheet or the second PC sheet (S902); and drying the applied adhesive (S903).

### INDUSTRIAL APPLICABILITY

As described hereinbefore, the present invention provides a flat prism sheet for backlight units and a method of manufacturing the same. According to the present invention, because prism-shaped protrusions are formed in the prism sheet, the defect rates attributable to scratching or the entry of impurities in the course of assembling a backlight unit may be drastically decreased. Further, the generation of shatter cracks resulting from friction with other sheets may be decreased, thus improving workability, and accordingly, the defect rates may be greatly decreased, resulting in improved productivity. Moreover, when the prism sheet is sold, there is no need to attach an adhesive sheet to both surfaces thereof, thus reducing selling expenses.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A flat prism sheet for backlight units, having flat upper and lower surfaces, a plurality of prism-shaped protrusions formed parallel to each other therein and extending in a direction parallel to the upper and lower surfaces thereof, and an air layer formed between the prism-shaped protrusions.

2. A flat prism sheet for backlight units, comprising:
a lower layer;
a first intermediate layer, formed on an upper surface of the lower layer and having a plurality of prism-shaped protrusions formed parallel to each other;
a second intermediate layer, formed on an upper surface of the first intermediate layer; and
an upper layer, formed on an upper surface of the second intermediate layer;
wherein an air layer is formed between a lower surface of the second intermediate layer and valleys of the prism-shaped protrusions of the first intermediate layer.

3. The prism sheet as set forth in claim 2, wherein the upper layer and the lower layer are formed of polyethyleneterephthalate (PET), and the first intermediate layer and the second intermediate layer are formed of a UV light-curable acrylic resin or a heat-curable acrylic resin.

4. A flat prism sheet for backlight units, comprising:
a lower layer;
an intermediate layer, formed on an upper surface of the lower layer and having a plurality of prism-shaped protrusions formed parallel to each other; and
an upper layer, formed on an upper surface of the intermediate layer;
wherein an air layer is formed between a lower surface of the upper layer and valleys of the prism-shaped protrusions of the intermediate layer, and ridges of the prism-shaped protrusions of the intermediate layer are integrated with the lower surface of the upper layer using an adhesive.

5. The prism sheet as set forth in claim 4, wherein the upper layer is formed of polyethyleneterephthalate (PET) or polycarbonate (PC), the lower layer is formed of polyethyleneterephthalate (PET), and the intermediate layer is formed of a UV light-curable acrylic resin or a heat-curable acrylic resin.

6. A flat prism sheet for backlight units, comprising:
a lower layer, having a plurality of prism-shaped protrusions formed parallel to each other; and
an upper layer, formed on an upper surface of the lower layer;
wherein an air layer is formed between a lower surface of the upper layer and valleys of the prism-shaped protrusions of the lower layer, and ridges of the prism-shaped protrusions of the lower layer are integrated with the lower surface of the upper layer using an adhesive.

7. The prism sheet as set forth in claim 6, wherein the upper layer is formed of polyethyleneterephthalate (PET) or polycarbonate (PC), and the lower layer is formed of polycarbonate (PC).

8. The prism sheet as set forth in claim 6, wherein a cross-section of each of the prism-shaped protrusions has a triangular shape, a pentagonal shape, or a heptagonal shape.

9. The prism sheet as set forth in claim 6, wherein the adhesive is any one selected from among highly transparent adhesives, including silicone-urethane (SU) hybrid polymers, acrylic polymers, and polyester based polymers.

10. The prism sheet as set forth in claim 2, wherein the first intermediate layer and the second intermediate layer are integrated with each other through fusion.

11. A method of manufacturing a flat prism sheet, comprising:
applying a first uncured resin on one surface of a first resin sheet;
passing the first resin sheet through a roll having prism-shaped recesses to thus form a first uncured resin layer having prism-shaped protrusions on the first resin sheet, and then radiating UV light or applying heat to the first uncured resin layer, thus curing the first uncured resin layer;
applying a second uncured resin on one surface of a second resin sheet, thus forming a second uncured resin layer;
bringing the first resin sheet into close contact with the second resin sheet so that ridges of the prism-shaped protrusions of the first resin sheet come into contact with the second uncured resin layer of the second resin sheet and thus overlap therewith; and
radiating UV light or applying heat to the second uncured resin layer, thus curing the second uncured resin layer.

12. The method as set forth in claim 11, wherein the first resin sheet and the second resin sheet are a polyethyleneterephthalate (PET) sheet, and the first uncured resin and the second uncured resin are a UV light-curable acrylic resin or a heat-curable acrylic resin.

13. A method of manufacturing a flat prism sheet, comprising:
applying an uncured resin on one surface of a first resin sheet;
passing the first resin sheet through a roll having prism-shaped recesses to thus form an uncured resin layer having prism-shaped protrusions on the first resin sheet, and then radiating UV light or applying heat to the uncured resin layer, thus curing the uncured resin layer;
applying an adhesive on ridges of the prism-shaped protrusions of the first resin sheet;
bringing the first resin sheet into close contact with a second resin sheet so that the ridges of the prism-shaped protrusions of the first resin sheet come into contact with one surface of the second resin sheet; and
drying the adhesive.

14. The method as set forth in claim 13, wherein the first resin sheet is a polyethyleneterephthalate (PET) sheet, the second resin sheet is a polyethyleneterephthalate (PET) sheet or a polycarbonate (PC) sheet, and the uncured resin is a UV light-curable acrylic resin or a heat-curable acrylic resin.

15. A method of manufacturing a flat prism sheet, comprising:
passing a first resin sheet through a heated roll having prism-shaped recesses to thus form the first resin sheet having prism-shaped protrusions, and then cooling the first resin sheet to cure it;
applying an adhesive on ridges of the prism-shaped protrusions of the first resin sheet;
bringing the first resin sheet into close contact with a second resin sheet so that the ridges of the prism-shaped protrusions of the first resin sheet come into contact with one surface of the second resin sheet; and
drying the adhesive.

16. The method as set forth in claim 15, wherein the first resin sheet is a polycarbonate (PC) sheet, and the second resin sheet is a polyethyleneterephthalate (PET) sheet or a polycarbonate (PC) sheet.

17. The method as set forth in claim 13, wherein the adhesive is any one selected from among highly transparent adhesives, including silicone-urethane (SU) hybrid polymers, acrylic polymers, and polyester based polymers.

18. The method as set forth in claim 11, wherein a cross-section of each of the prism-shaped protrusions has a triangular shape, a pentagonal shape, or a heptagonal shape.

19. The method as set forth in claim 11, wherein the bringing the first resin sheet into close contact with the second resin sheet is conducted in a state in which the first resin sheet is positioned on the second resin sheet.

20. The method as set forth in claim 15, wherein the adhesive is any one selected from among highly transparent adhesives, including silicone-urethane (SU) hybrid polymers, acrylic polymers, and polyester based polymers.
